(19) United States
(12) Patent Application Publication
(10) Pub. No.: US 2026/0283131 A1
(43) Pub. Date: Sep. 24, 2026

(54) FISHING TACKLE BOX

(71) Applicant: Gilbert Gallegos, Lake Havasu City, AZ (US)

(72) Inventor: Gilbert Gallegos, Lake Havasu City, AZ (US)

(21) Appl. No.: 19/087,796

(22) Filed: Mar. 24, 2025

(51) Int. Cl. A01K 97/06

(52) U.S. Cl. CPC A01K 97/06

(57) ABSTRACT

A fishing tackle box includes a first shell and a second shell, a coupler, a first lure holder, and a second lure holder. The second shell is pivotably coupled to the first shell. Each of the first shell and the second shell has a main wall and a perimeter wall. The coupler includes a first coupler member on the first shell and a second coupler member on the second shell. The first lure holder is inserted in the first shell. The first lure holder includes a soft material designed to be pierced by hooks of fishing lures to hold fishing lures in place separated from one another. The second lure holder is inserted in the second shell. The second lure holder includes a soft material designed to be pierced by hooks of the fishing lures to hold the fishing lures in place separated from one another.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to tackle boxes and more particularly pertains to a new fishing tackle box for safely holding fishing lures. Tackle boxes and similar container for fishing lures are made of hard plastic or metal that damage the lures. The new fishing tackle box includes soft material to comfortably hold fishing lures.

### (2) Description of Related Art Including Information Disclosed Under 37 CFR 1.97 and 1.98.

The prior art relates to tackle boxes. The prior art, as best understood, does not disclose a fishing tackle box that includes a first shell and a second shell, a coupler, a first lure holder, and a second lure holder. Each of the first lure holder and the second lure holder includes a soft material designed to be pierced by hooks of fishing lures to hold fishing lures in place separated from one another.

### (h) BRIEF SUMMARY OF THE INVENTION

An embodiment of the disclosure meets the needs presented above in a fishing tackle box generally comprising a first shell and a second shell, a coupler, a first lure holder, and a second lure holder. The second shell is pivotably coupled to the first shell. Each of the first shell and the second shell has a main wall and a perimeter wall. The coupler includes a first coupler member on the first shell and a second coupler member on the second shell. The first lure holder is inserted in the first shell. The first lure holder includes a soft material designed to be pierced by hooks of fishing lures to hold fishing lures in place separated from one another. The second lure holder is inserted in the second shell. The second lure holder includes a soft material designed to be pierced by hooks of the fishing lures to hold the fishing lures in place separated from one another.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a fishing tackle box according to an embodiment of the disclosure.

FIG. 2 is a top view of an embodiment of the disclosure.

FIG. 3 is a front open view of an embodiment of the disclosure.

FIG. 4 is a front closed view of an embodiment of the disclosure.

FIG. 5 is a side cross-sectional view of an embodiment of the disclosure.

FIG. 6 is a perspective view of an alternative embodiment of the disclosure.

### (j) DETAILED DESCRIPTION OF THE INVENTION

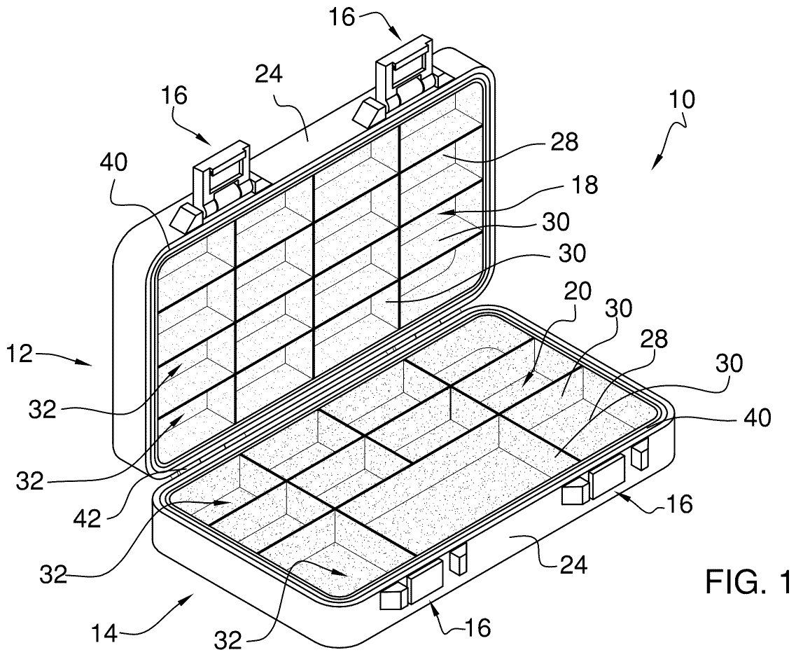

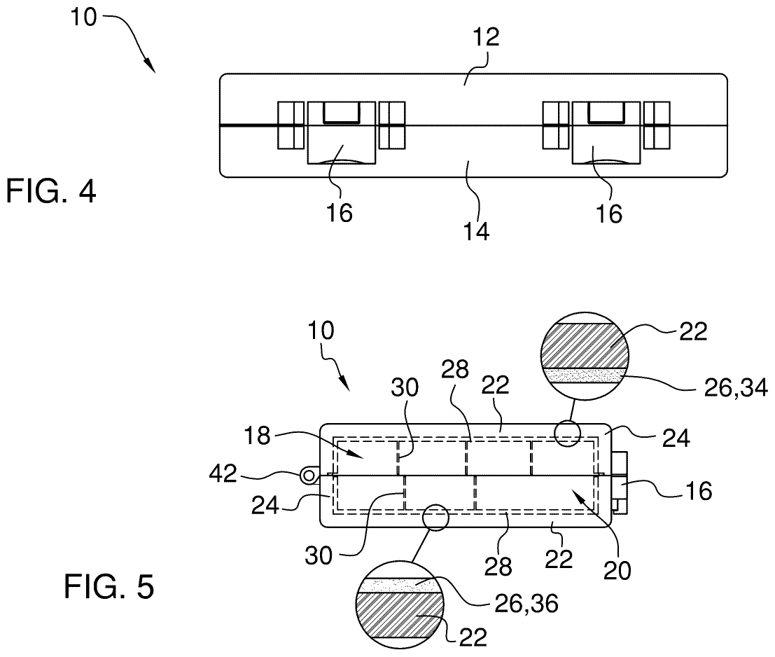

With reference now to the drawings, and in particular to FIGS. 1 through 6 thereof, a new fishing tackle box embodying the principles and concepts of an embodiment of the disclosure and generally designated by the reference numeral 10 will be described.

As best illustrated in FIGS. 1 through 6, the fishing tackle box 10 generally comprises a first shell 12 and a second shell 14, a coupler 16, a first lure holder 18, and a second lure holder 20. The second shell 14 is pivotably coupled to the first shell 12. Each of the first shell 12 and the second shell 14 has a main wall 22 and a perimeter wall 24. The coupler 16 includes a first coupler 16 member on the first shell 12 and a second coupler 16 member on the second shell 14. The first lure holder 18 is inserted in the first shell 12. The first lure holder 18 includes a soft material 26 designed to be pierced by hooks 62 of fishing lures 60 to hold fishing lures 60 in place separated from one another. The second lure holder 20 is inserted in the second shell 14. The second lure holder 20 includes a soft material 26 designed to be pierced by hooks 62 of the fishing lures 60 to hold the fishing lures 60 in place separated from one another.

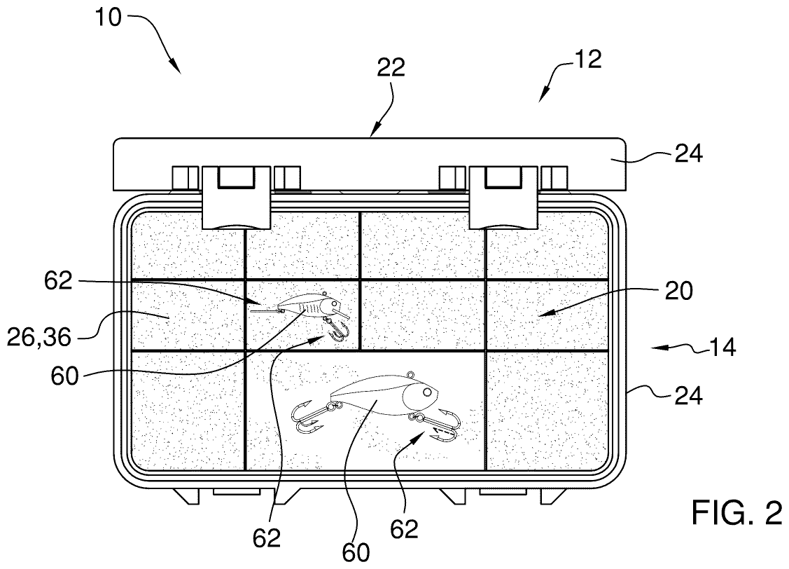

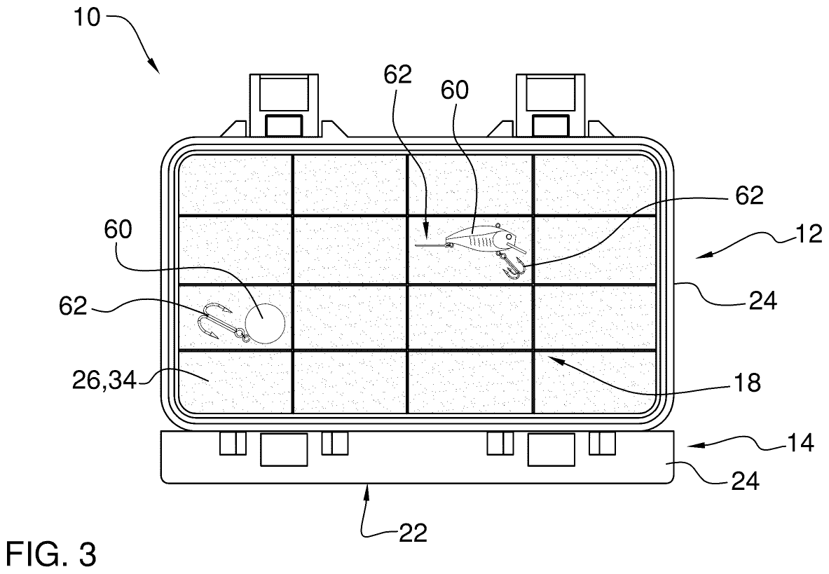

In the exemplary embodiment in FIGS. 1 through 5, each of the first lure holder 18 and the second lure holder 20 includes a base panel 28 and a plurality of walls 30 projecting perpendicularly from the base panel 28. The base panel 28 of each of the first lure holder 18 and the second lure holder 20 is positioned over the main wall 22 of a respective one of the first shell 12 and the second shell 14. Each of the walls 30 is positioned to form individual compartments 32. Each of the compartments 32 is designed to hold a respective one of the fishing lures 60. The compartments 32 can all be the same size, as shown in FIG. 3, or can be different sizes to hold different-sized lures, as shown in FIG. 2.

As mentioned above, each of the first lure holder 18 and the second lure holder 20 includes the soft material 26. The soft material 26 could be foam material 34 or felt material 36, or possibly other materials, such as textile or fabric. The foam material 34 or the felt material 36 could be on the base panel 28, the walls 30, or both, in any combination. In the exemplary embodiment in FIG. 1, the base panel 28 of the first lure holder 18 includes the foam material 34 and the base panel 28 of the second lure holder 20 includes the felt material 36. In addition, each of the walls 30 of the first lure holder 18 includes the foam material 34 and each of the walls 30 of the second lure holder 20 includes the felt material 36. However, in another possible embodiment, both the first lure holder 18 and the second lure holder 20 could be made of foam or felt. In yet another possible embodiment, the base panel 28 could have felt material 36 and the walls 30 have foam material 34, or vice versa. In another possible embodiment, each of the base panel 28 and the walls 30 could be made entirely of the soft material 26, the soft material 26 could be placed on a substrate, such as plastic, metal, or cardboard.

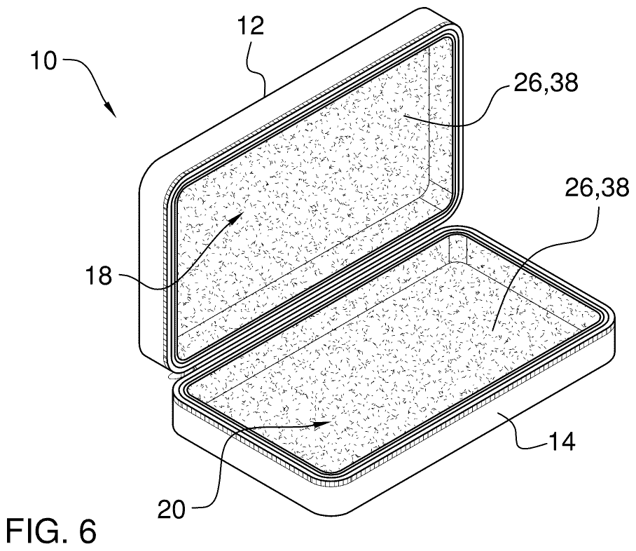

FIG. 6 shows an alternative embodiment without the compartments 32. In this embodiment, each of the first lure holder 18 and the second lure holder 20 is a sheepskin liner 38 covering at least the main wall 22 of the respective one of the first shell 12 and the second shell 14. In the exemplary embodiment in FIG. 6, the sheepskin liner 38 extends over the entire inner surface of the first shell 12 and the second shell 14, covering the main wall 22 and the perimeter wall 24.

As shown in FIG. 1, each of the first shell 12 and the second shell 14 includes a waterproof seal 40 about a lip of the perimeter wall 24. The waterproof seal 40 could be rubber or an elastomer.

The fishing tackle box 10 further includes a hinge 42 to pivotably connect the first shell 12 and the second shell 14. Each of the first shell 12 and the second shell 14 is made of a rigid waterproof material, such as plastic or metal. In the exemplary embodiment in FIG. 1, there are two couplers 16 in the form of latches, though other couplers 16 such as snaps or clasps could be used.

The fishing tackle box 10 is used to hold fishing lures 60 in a cushioned manner. The hooks 62 of the fishing lures 60 can be inserted into the soft material 26, whether foam or felt or sheepskin, to hold the fishing lures 60 in place. Since the fishing lures 60 are hooked into the soft material 26, the fishing lures 60 will not move or fall out of the first lure holder 18 or the second lure holder 20, regardless of the orientation of the fishing tackle box 10.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A fishing tackle box comprising:
a first shell and a second shell, the second shell being pivotably coupled to the first shell, each of the first shell and the second shell having a main wall and a perimeter wall;
a coupler, the coupler including a first coupler member on the first shell and a second coupler member on the second shell;
a first lure holder, the first lure holder being inserted in the first shell, the first lure holder comprises a soft material configured to be pierced by hooks of fishing lures to hold the fishing lures in place separated from one another;
a second lure holder, the second lure holder being inserted in the second shell, the second lure holder comprises a soft material configured to be pierced by hooks of the fishing lures to hold the fishing lures in place separated from one another;
wherein each of the first lure holder and the second lure holder includes a base panel and a plurality of walls projecting perpendicularly from the base panel;
wherein the base panel of each of the first lure holder and the second lure holder is positioned over the main wall of a respective one of the first shell and the second shell;
wherein each of the walls is positioned to form individual compartments;
wherein each of the compartments is configured to hold a respective one of the fishing lures; and
wherein the base panel of the first lure holder comprises a foam material and the base panel of the second lure holder comprises a felt material.

2. (canceled)

3. (canceled)

4. (canceled)

5. The fishing tackle box of claim 1, wherein each of the walls comprises a foam material.

6. The fishing tackle box of claim 1, wherein each of the walls comprises a felt material.

7. (canceled)

8. The fishing tackle box of claim 1, wherein each of the walls of the first lure holder comprises a foam material and each of the walls of the second lure holder comprises a felt material.

9. The fishing tackle box of claim 1, wherein each of the walls of the first lure holder comprises a foam material and each of the walls of the second lure holder comprises a felt material.

10. The fishing tackle box of claim 1, wherein each of the first shell and the second shell includes a waterproof seal about a lip of the perimeter wall.

11. The fishing tackle box of claim 1, wherein the fishing tackle box further comprises a hinge to pivotably connect the first shell and the second shell.

12. The fishing tackle box of claim 1, wherein each of the first shell and the second shell is made of a rigid waterproof material.

13. The fishing tackle box of claim 1, wherein each of the first lure holder and the second lure holder is a sheepskin liner covering at least the main wall of the respective one of the first shell and the second shell.

14. The fishing tackle box of claim 13, wherein:
each of the first shell and the second shell includes a waterproof seal about a lip of the perimeter wall;
the fishing tackle box further comprises a hinge to pivotably connect the first shell and the second shell; and
each of the first shell and the second shell is made of a rigid waterproof material.

15. The fishing tackle box of claim 8, wherein:
each of the first shell and the second shell includes a waterproof seal about a lip of the perimeter wall;
the fishing tackle box further comprises a hinge to pivotably connect the first shell and the second shell; and
each of the first shell and the second shell is made of a rigid waterproof material.
